(19) United States
(12) Patent Application Publication
(10) Pub. No.: US 2018/0158090 A1
(43) Pub. Date: Jun. 7, 2018

(54) DYNAMIC REAL-TIME SERVICE FEEDBACK COMMUNICATION SYSTEM

(71) Applicant: Maritz Holdings Inc., Fenton, MO (US)

(72) Inventors: Kristina Glynn, St. Louis, MO (US); Kimberly J. Lanier, San Antonio, TX (US); Jason Butler, St. Louis, MO (US)

(73) Assignee: Maritz Holdings Inc., Fenton, MO (US)

(21) Appl. No.: 15/833,326

(22) Filed: Dec. 6, 2017

Related U.S. Application Data
(60) Provisional application No. 62/430,466, filed on Dec. 6, 2016.

(51) Int. Cl. G06Q 30/02; G06F 17/30; H04L 29/08

(52) U.S. Cl. CPC G06Q 30/0218; H04L 67/10; G06F 17/30412; G06Q 30/0203

(57) ABSTRACT

Providing dynamic real-time feedback to participant computing devices in a communication system to increase participant engagement with service performance. In an embodiment, a real-time engagement application executing on an engagement computing device transmits feedback and/or rewards data to a participant computing device via a communications network.

### CROSS-REFERENCE TO RELATED APPLICATION

This application claims priority to U.S. Provisional Patent Application Ser. No. 62/430,466, filed Dec. 6, 2016, the entire contents of which are expressly incorporated herein by reference, including the contents and teachings of any references contained therein.

### BACKGROUND

Aspects of the present invention generally relate to the field of computing devices communicatively connected by a telecommunications network to provide a dynamic, real-time feedback conduit from customers directly to individuals (e.g., employees, participants) who rendered service to the customers, and combine the feedback with other reward and recognition programs.

Conventional customer feedback techniques collect feedback data from customers and present it to supervisors, such as managers, who then share the feedback with employees in the form of scores. These techniques aggregate feedback at a level higher than individual employees, for example by aggregating feedback for all employees under a certain supervisor and/or at a certain location. Moreover, the data is communicated to the employees at certain intervals, such as weekly or monthly meetings, for example. The conventional techniques fail to inform employees in a timely manner which service aspects contribute to feedback scores and how to improve the scores. Other conventional techniques focus exclusively on customer feedback and are unable to combine this with other reward and recognition aspects.

### SUMMARY

Aspects of the invention relate to networked computing devices and communication systems that provide customer feedback and/or rewards to participants (e.g., employees) dynamically in real-time to increase participant engagement with service performance and combine the rewards with other reward earning opportunities. Beneficially, the systems and methods described herein provide real-time feedback directly to a participant device and the feedback includes data about the service aspects that contributed to the feedback and how to improve those aspects. Real-time feedback aspects of the invention enable participants to correct errors and improve service performance without requiring supervisor review.

A system embodying aspects of the invention includes an engagement computing device and a participant computing device. The participant computing device is communicatively coupled to the engagement computing device via a communications network. A real-time engagement application executing on the engagement computing device is configured to aggregate survey data received from a survey computing device, analyze the aggregated survey data with one or more rules, and generate a response insights display including the analyzed survey data. The executing real-time engagement application is also configured to transmit the response insights display to the participant computing device in real-time via the communications network. In an embodiment, the executing real-time engagement application is optionally configured to reward participants for achieving prescribed response thresholds, and combine reward earnings with other program earnings.

Other objects and features will be in part apparent and in part pointed out hereinafter.

### BRIEF DESCRIPTION OF THE DRAWINGS

FIG. 1 illustrates an exemplary real-time engagement system according to an embodiment.

FIG. 2 illustrates an exemplary data flow of the real-time engagement system of FIG. 1.

FIG. 3 illustrates an exemplary architecture of an engagement computing device according to an embodiment.

FIG. 4 is a flowchart of an exemplary real-time engagement process for a plurality of participants according to an embodiment.

FIGS. 5-7 are exemplary screenshots of a real-time engagement application executing on a computing device to perform the real-time engagement process of FIG. 4.

FIG. 8 is a flowchart of an exemplary real-time engagement process for an individual participant according to an embodiment.

FIG. 9 illustrates exemplary screenshots of a customer feedback event according to an embodiment.

FIG. 10 illustrates exemplary screenshots of a manager feedback event according to an embodiment.

FIGS. 11-13 illustrate exemplary screenshots of a participant feedback event according to an embodiment.

FIG. 14 is a flowchart of an exemplary rule building process according to an embodiment.

Corresponding reference characters indicate corresponding parts throughout the drawings.

### DETAILED DESCRIPTION

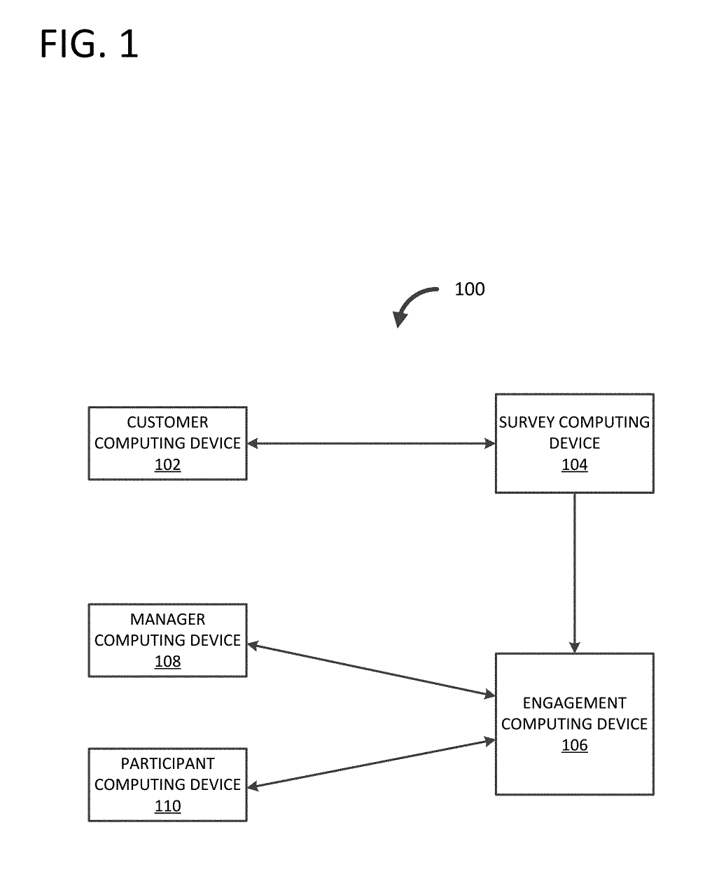

FIG. 1 illustrates an exemplary real-time engagement system, generally indicated at 100, in accordance with an aspect of the invention. The system 100 includes a customer computing device 102, a survey computing device 104, an engagement computing device 106, a manager computing device 108, and a participant computing device 110. The customer computing device 102 is communicatively coupled to the survey computing device 104, which is in turn communicatively coupled to the engagement computing device 106. The engagement computing device 106 is also communicatively coupled to the manager computing device 108 and the participant computing device 110.

The customer computing device 102 is configured to receive input (e.g., via a touchscreen, a keyboard, etc.) regarding physical, relational, and/or quality aspects of a service experience and/or an individual participant's (e.g., employee's) delivery of the service experience. In an embodiment, customer computing device 102 displays an editable survey with questions about the experience. In accordance with an aspect of the invention, customer computing device 102 may be a smartphone, a tablet computing device, a wearable computing device, a desktop computing device, and the like.

The survey computing device 104 is configured to provide surveys to customer computing device 102 via a communications network. The survey computing device 104 is also configured to receive completed surveys from customer computing device 102 via the communications network and process the received surveys. In an embodiment, surveys include survey questions designed to meet survey goals and objectives, program goals and objectives, and include questions about participant behavior. In one form, survey computing device 104 is a server computing device. The survey computing device 104 may be provided by a third party vendor. In an embodiment, survey computing device 104 transmits survey results to engagement computing device 106 via a communications network, such as by web services, a file transfer protocol (FTP), and the like.

The engagement computing device 106 is configured to receive and analyze survey results in real-time. As used herein, real-time means that a computing device (e.g., engagement computing device 106) is configured to analyze (e.g., process) survey results relatively quickly (e.g., within a short temporal period, such as within milliseconds, etc.) after receiving so that it is available substantially immediately as feedback. In an embodiment, engagement computing device 106 is configured to aggregate customer feedback ratings and utilize rules to determine if desired satisfaction levels were achieved by a group of participants. In this embodiment, participants earn rewards as a group when a shared location (e.g., workplace, store, branch, campus, plant, etc.) of the group achieves a configured customer satisfaction level. In another embodiment, engagement computing device 106 is configured to aggregate individual participant performance, such as into positive, neutral, or negative status indicators, for example. In this embodiment, participants earn rewards individually (i.e., without regard to other participants) when the participant achieves a desired satisfaction level. In accordance with an aspect of the invention, engagement computing device 106 may be a server computing device, one or more computing devices communicatively connected in a cloud environment, and the like. Additional details regarding engagement computing device 106 are provided herein.

The manager computing device 108 and participant computing device 110 are each configured to display customer feedback, survey results, and/or rewards data received from engagement computing device 106 via a communications network. The manager computing device 108 is further configured to display a rule builder for generating rules against which survey results are evaluated, as further described herein. In accordance with an aspect of the invention, manager computing device 108 and participant computing device 110 may each be a smartphone, a tablet computing device, a wearable computing device, a desktop computing device, and the like.

In an embodiment, the system 100 includes a communications infrastructure (e.g., communications network) capable of facilitating the exchange of data among various components of system 100. The communications infrastructure may include a local area network (LAN) that is connectable to other telecommunications networks, including other LANs or portions of the Internet or an intranet. The communications infrastructure may also be any telecommunications network that facilitates the exchange of data, such as those that operate according to the IEEE 802.3 (e.g., Ethernet) and/or the IEEE 802.11 (e.g., Wi-Fi) protocols, for example. In other embodiments, the communications infrastructure is any medium that allows data to be physically transferred through serial or parallel communication channels (e.g., copper wire, optical fiber, computer bus, wireless communication channel, etc.).

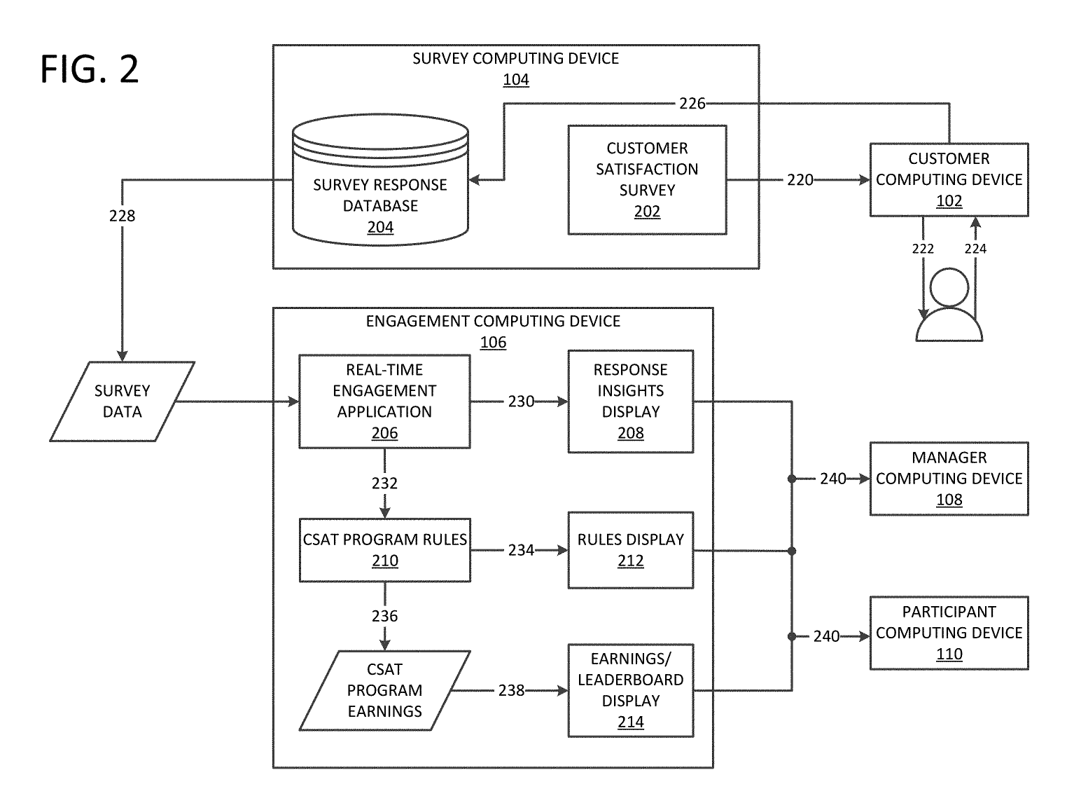

FIG. 2 illustrates an exemplary data flow process of real-time engagement system 100. In an embodiment, a customer satisfaction survey 202 is transmitted (220) to customer computing device 102, which displays (222) the survey 202 to a customer. By utilizing the customer computing device 102, the customer responds (224) to survey questions about a service experience provided by a participant associated with participant computing device 110. Upon receiving the completed survey 202, survey computing device 104 stores (226) the survey results in a survey response database 204. The results stored in survey response database 204 are then transmitted (228) via the communications network to engagement computing device 106.

Upon receiving the survey results, a real-time engagement application 206 executing on engagement computing device 106 generates (230) a response insights display 208 and analyzes (232) the survey results using CSAT program rules engine 210 to generate (234) a rules display 212. Depending upon whether customer satisfaction, as indicated in the survey results, meets or exceeds the rules in CSAT program rules engine 210, CSAT program earnings (e.g., points) are accrued (236) and displayed (238) via an earnings/leaderboard display 214. The earnings/leaderboard display 214 also includes a leaderboard that shows the names and scores of participants relative to each other and/or shared locations of participants relative to each other. In an embodiment, earnings/leaderboard display 214 comprises, at least in part, combined earnings as further described herein. The manager computing device 108 and participant computing device 110 are each configured to display (240) the response insights display 208, rules display 212, and/or earnings display 214.

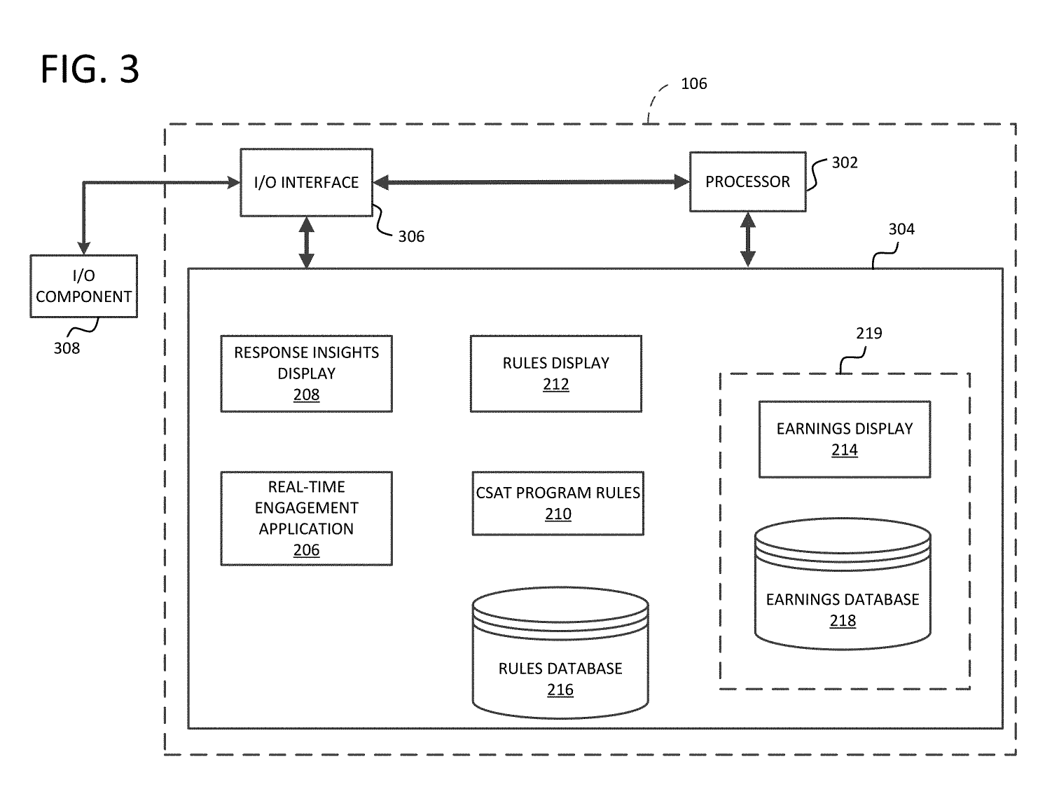

FIG. 3 illustrates an exemplary architecture of engagement computing device 106 programmed to provide aspects of real-time engagement in accordance with an aspect of the present invention via a software environment. In this embodiment, engagement computing device 106 includes a processor 302, a memory 304, and an input/output (I/O) interface 306 that interfaces with an I/O component 308. The memory 304 includes real-time engagement application 206, response insights display 208, CSAT program rules 210, rules display 212, and earnings display 214 embodied in processor-executable instructions for executing by processor 302. In this manner, engagement computing device 106 comprises a special-purpose computing device for real-time engagement with manager computing device 108 and/or participant computing device 110.

In accordance with one or more aspects of the disclosure, earnings display 214 and an earnings database 218 comprise combined earnings 219. In this manner, real-time engagement system 100 enables the combination of participant rewards received from customers (e.g., customer computing devices 102) with other rewards. For example, peers of the participant can provide eCards and social recognition (e.g., for any sort of behavior reinforcement), managers of the participant can provide eCards and/or points (e.g., for any program created by a sponsor, such as a human resources department), and administrators of the program may create additional programs to recognize and reward behaviors that go beyond rendering service to customers (e.g., wellness programs, innovation programs, performance programs, incentive programs, leadership programs, etc.). In an embodiment, real-time engagement system 100 combines all of the rewards and/or points from these other programs with the rewards earned via system 100 (e.g., CSAT program earnings, etc.) into a single account (e.g., earnings database 218, etc.) as combined earnings 219.

The processor 302, memory 304, and I/O interface 306 are communicatively connected and/or electrically connected to each other. The I/O interface 306 is communicatively and/or electrically connected to the I/O component 308. The processor 302 is adapted to execute processor-executable instructions stored in the memory 304 for implementing the engagement in real time. The I/O interface 306 of FIG. 3 provides a physical data connection between engagement computing device 106 and I/O component 308. In an embodiment, I/O interface 306 is a network interface card (NIC) or modem and I/O component 308 is a communications infrastructure (e.g., telecommunications network) as further described herein.

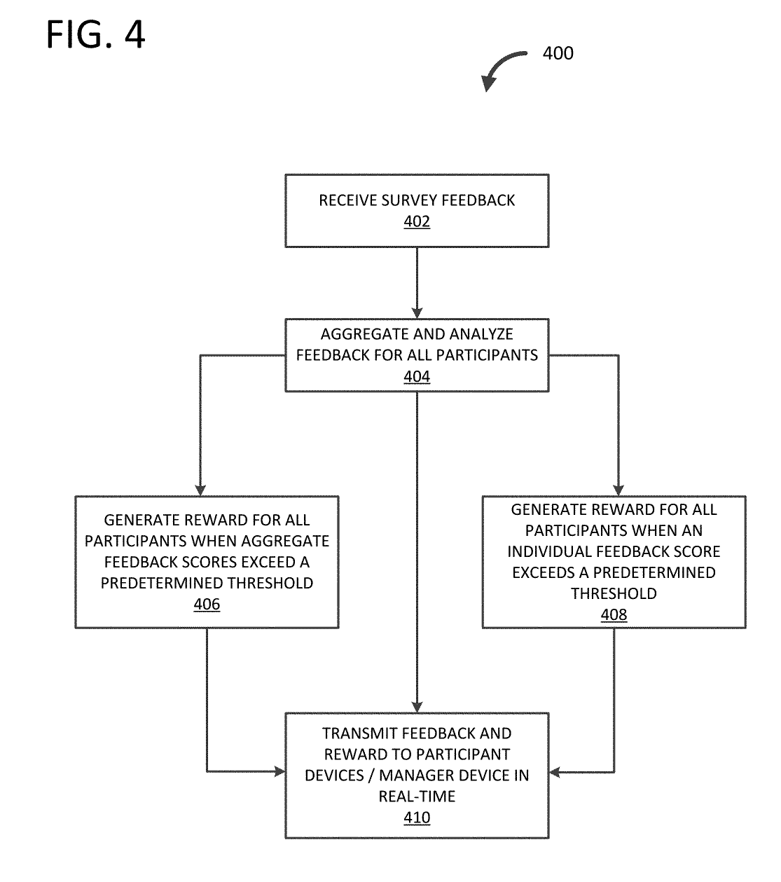

FIG. 4 illustrates an exemplary real-time engagement process, generally indicated at 400, for a plurality of participants in accordance with an aspect of the invention. At step 402, real-time engagement application 206 executing on engagement computing device 106 receives survey feedback from survey computing device 104. The real-time engagement application 206, at step 404, aggregates and analyzes the received survey feedback with rules (e.g., CSAT program rules engine 210) for all participants. In other words, feedback scores for all participants having a common identifying property (e.g., the same location, branch, store, shift, supervisor, etc.) are aggregated and analyzed together.

At step 406, real-time engagement application 206 executing on engagement computing device 106 generates a reward for a plurality of participants having a common identifying property when the aggregate feedback scores for that identifying property exceed a predetermined threshold. For example, when the average response of all customer feedback for a particular location received within a month exceeds a predetermined threshold of X then all participants at that location earn a reward Y. Other examples include, but are not limited to, “Participants each earn 500 points when their location's score exceeds 4.0 out of 5.0 during a quarter” and “Participants each earn 1,000 points when their location is among the top 50 locations based upon customer satisfaction scores within a quarter.”

At step 408, real-time engagement application 206 executing on engagement computing device 106 generates a reward for all participants when a particular feedback score exceeds a predetermined threshold. For example, when a customer feedback is “perfect” (e.g., maximum scores are achieved for all feedback categories) then all participants at that location earn a reward Z. Steps 406 and 408 may be performed independently of each other or concurrently in accordance with an aspect of the invention. In an embodiment, the feedback score may not qualify for a reward and the process continues to step 410.

At step 410, real-time engagement application 206 executing on engagement computing device 106 transmits data regarding the received survey feedback and any generated rewards to participant computing device 110 of each participant in real-time. Additionally or alternatively, real-time engagement application 206 executing on engagement computing device 106 transmits data regarding the received survey feedback and any generated rewards to manager computing device 108 in real-time. In this manner, manager computing device 108 and real-time engagement application 206 enable managers to view reports relative to customer feedback events, establish goals for a participant, and/or track participant progress. In an embodiment, real-time engagement application 206 executing on engagement computing device 106 transmits data regarding combined earnings 219 to participant computing device 110 of each participant and/or manager computing device 108 in real-time at 410. In another embodiment, real-time engagement application 206 executing on engagement computing device 106 transmits rewards from other, non-CSAT-related programs to participant computing device 110 of each participant and/or manager computing device 108 in real-time at 410.

In an embodiment, individual customer feedback events that achieve outstanding thresholds can result in case management events (e.g., managed by real-time engagement application 206) in which the manager of a location can individually recognize teams of participants or individual participants. Examples include, but are not limited to, “When a customer feedback event achieves a 5.0 out of 5.0, all participants in the location receive an award” and “When a customer feedback event mentions a participant by name, that participant receives an individual recognition.”

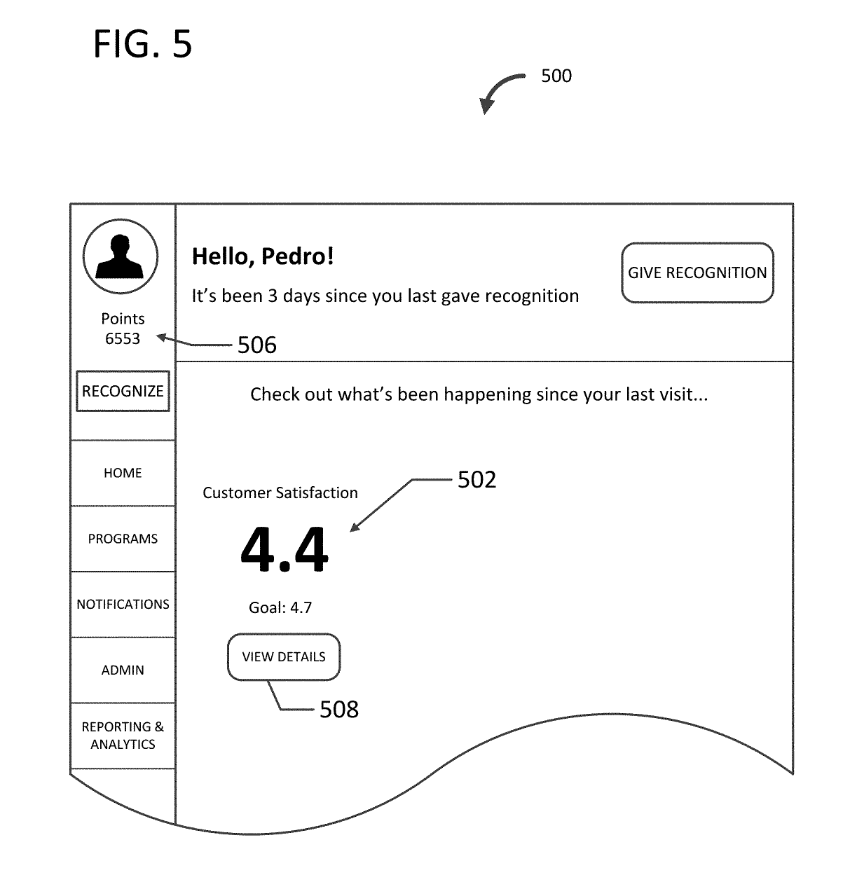

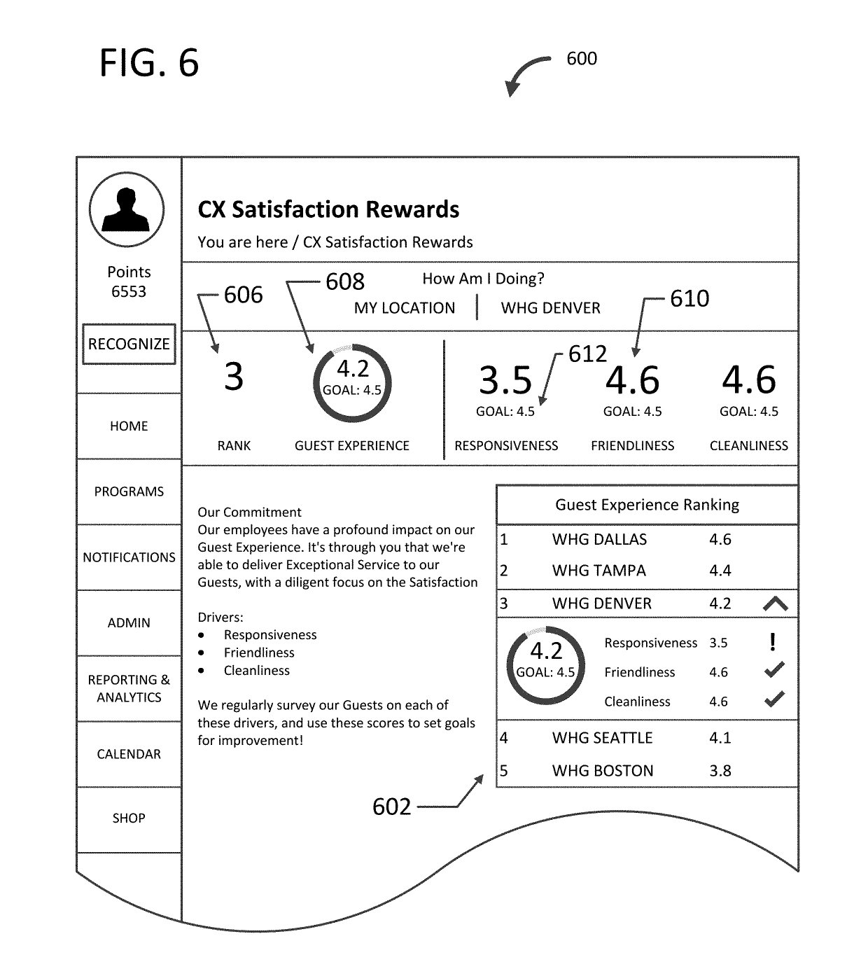

FIG. 5 illustrates an exemplary screenshot 500 generated by real-time engagement application 206 for display on participant device 110. The screenshot 500 includes aggregate (e.g., location-based) scoring from feedback data received from survey computing device 104. The exemplary aggregate score 502 in the illustrated embodiment is 4.4 with a goal of 4.7. The screenshot 500 also includes a total number of accrued points/awards 506 for the participant (e.g., 6553). Selection of a “View Details” button 508, such as by tapping a touchscreen device and/or selection via a mouse, provides additional details as illustrated by FIG. 6.

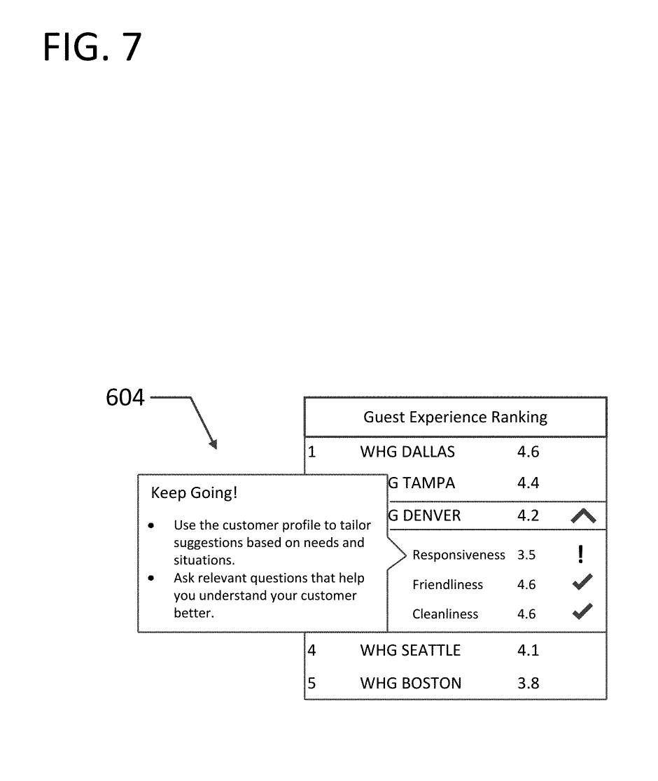

FIG. 6 illustrates an exemplary details screenshot 600 generated by real-time engagement application 206 for display on participant device 110. The screenshot 600 includes a leaderboard 602 (e.g., a ranking report of locations by score level), an information box 604 on how to improve the score (see FIG. 7), a rank indicia 606, an overall score indicia 608, score sub-dimension indicia 610, and information 612 about how to earn rewards (e.g., the thresholds that must be exceeded to earn rewards). In the embodiment illustrated in FIG. 6, for example, sub-dimensions responsiveness, friendliness, and cleanliness comprise the overall score for guest experience. The sub-dimensions enable a participant to understand which particular area(s) are contributing to an overall score below the threshold so that the participant can focus attention and/or receive coaching (e.g., from management or application) on that area to improve the overall score. For example, the participant can understand that the friendliness and cleanliness sub-dimensions are sufficient but improvement should be made for responsiveness in order to raise the overall score. In an embodiment, the information box 604 on how to improve the scores is provided in response to a user selecting (e.g., hovering over with a cursor, etc.) a top-level score (e.g., rank indicia 606, overall score indicia 608, one or more score sub-dimension indicia 610, etc.).

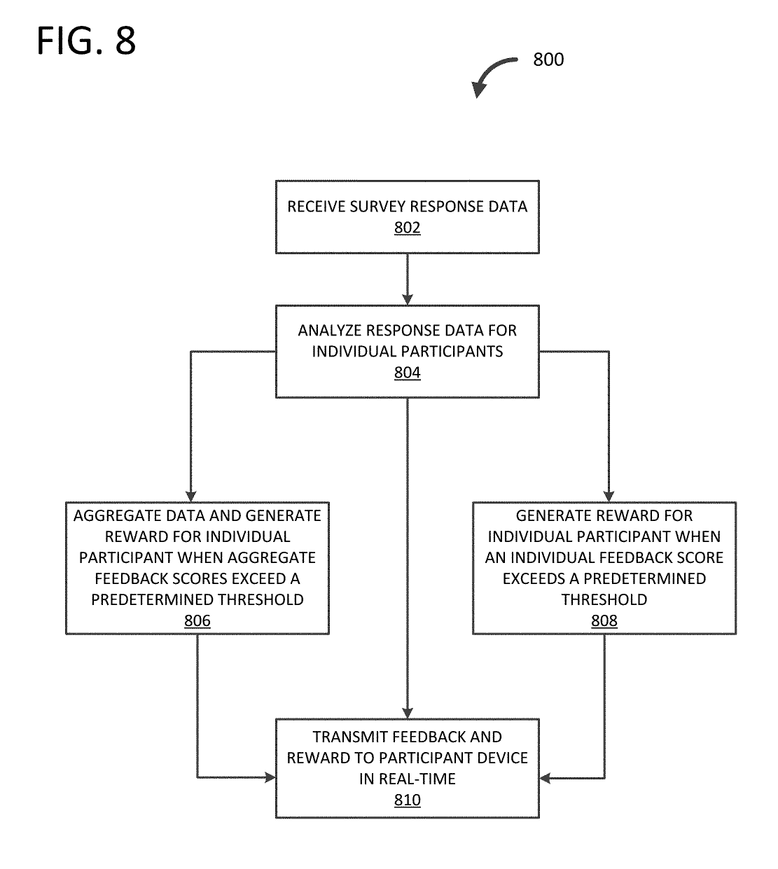

FIG. 8 illustrates an exemplary real-time engagement process, generally indicated at 800, for an individual participant in accordance with an aspect of the invention. At step 802, real-time engagement application 206 executing on engagement computing device 106 receives survey response data (e.g., feedback) from survey computing device 104. The real-time engagement application 206, at step 804, analyzes the received survey response data feedback with rules (e.g., CSAT program rules engine 210) for individual participants. In other words, feedback scores for a particular participant are aggregated and analyzed together. In an embodiment, the feedback event can uniquely and systematically identify an individual participant associated with the feedback.

At step 806, real-time engagement application 206 executing on engagement computing device 106 aggregates the received survey response data and generates a reward for the individual participant when the aggregate feedback scores for the individual participant exceed a predetermined threshold. In an exemplary embodiment, when a participant receives five positive customer feedback events, real-time engagement application 206 awards a monetary recognition to the participant. In another embodiment, the earnings from the monetary recognition event are combined with other program earnings as further described herein.

At step 808, real-time engagement application 206 executing on engagement computing device 106 generates a reward for the individual participant when a particular feedback score exceeds a predetermined threshold. For example, when a customer provides a positive response via the survey for an experience directly associated with a participant (e.g., mentioned by name in the feedback, associated by transactional data, etc.) real-time engagement application 206 awards a monetary recognition to the participant. Steps 806 and 808 may be performed independently of each other or concurrently, in accordance with an aspect of the invention. In an embodiment, the feedback scores for the individual participant may not qualify for a reward and the process continues to step 810.

At step 810, real-time engagement application 206 executing on engagement computing device 106 transmits data regarding the received survey feedback and any generated rewards to participant computing device 110 of the individual participant in real-time. For example, transmitting all customer feedback events specifically related to the individual participant (e.g., positive and negative) enables the participant to review the feedback events in real-time and adjust service performance accordingly. Additionally or alternatively, real-time engagement application 206 executing on engagement computing device 106 transmits data regarding the received survey feedback and any generated rewards to manager computing device 108 in real-time. In this manner, manager computing device 108 and real-time engagement application 206 enable managers to view reports relative to customer feedback events, establish goals for the participant, and/or track participant progress. In an embodiment, real-time engagement application 206 executing on engagement computing device 106 transmits data regarding combined earnings 219 to participant computing device 110 of each participant and/or manager computing device 108 in real-time at 810. In another embodiment, real-time engagement application 206 executing on engagement computing device 106 transmits rewards from other, non-CSAT-related programs to participant computing device 110 of each participant and/or manager computing device 108 in real-time at 810.

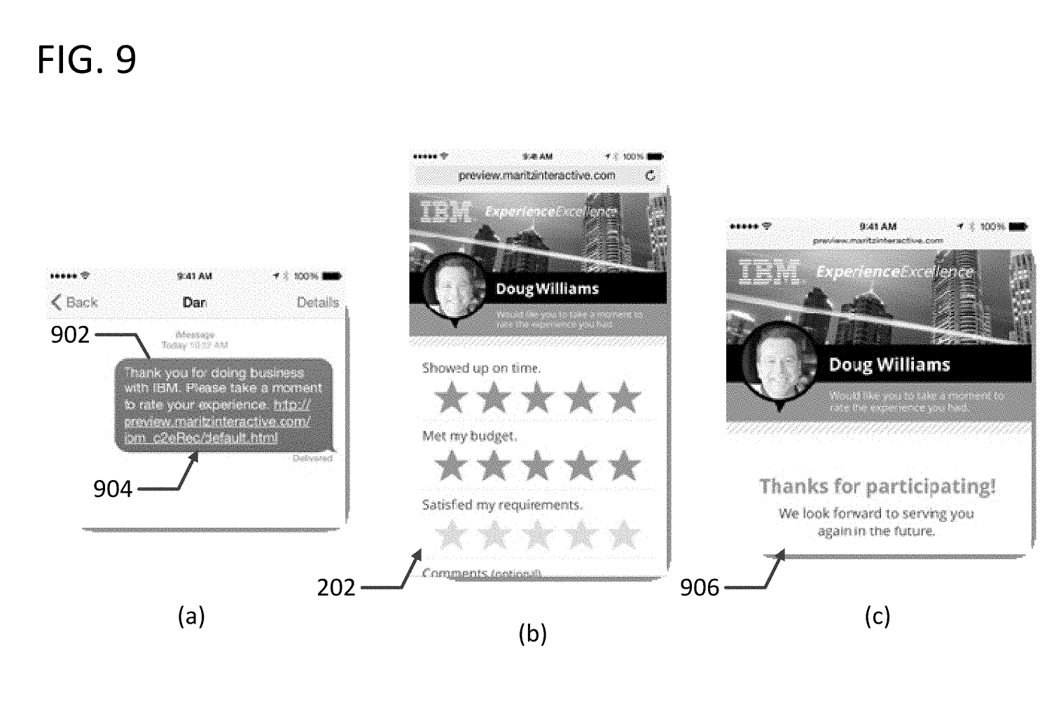

FIG. 9 illustrates aspects of an exemplary customer feedback event in accordance with an aspect of the invention. As shown in frame (a), a communication is transmitted to customer computing device 102, which displays the communication in the form of a text message 902 with a link 904 (e.g., uniform resource locator (URL)) to customer satisfaction survey 202 in response to receiving it. Selection of the link 904 causes customer computing device 102 to load customer satisfaction survey 202 from survey computing device 104 and display the customer satisfaction survey 202 in response to receiving it. In the exemplary illustrated embodiment, customer satisfaction survey 202 includes categories about participant timeliness, budget concerns, and requirement concerns and the ability to rank the participant with zero to five stars. One having ordinary skill in the art will understand that customer satisfaction survey 202 may additionally or alternatively include other items, such as environmental, relational, and/or experiential measures in which the manner of execution by a participant (e.g., employee) is directed by clients to form a differentiating value proposition for the customer or brand. Upon completion of the customer satisfaction survey 202, customer computing device 102 transmits data representative of the completed survey 202 to survey computing device 104. The survey computing device 104 stores the completed survey 202 in survey response database 204, as described further herein. The survey computing device 104 also transmits a confirmation screen 906 to customer computing device 102, which displays the confirmation screen 906 in response to receiving it, as illustrated by frame (c).

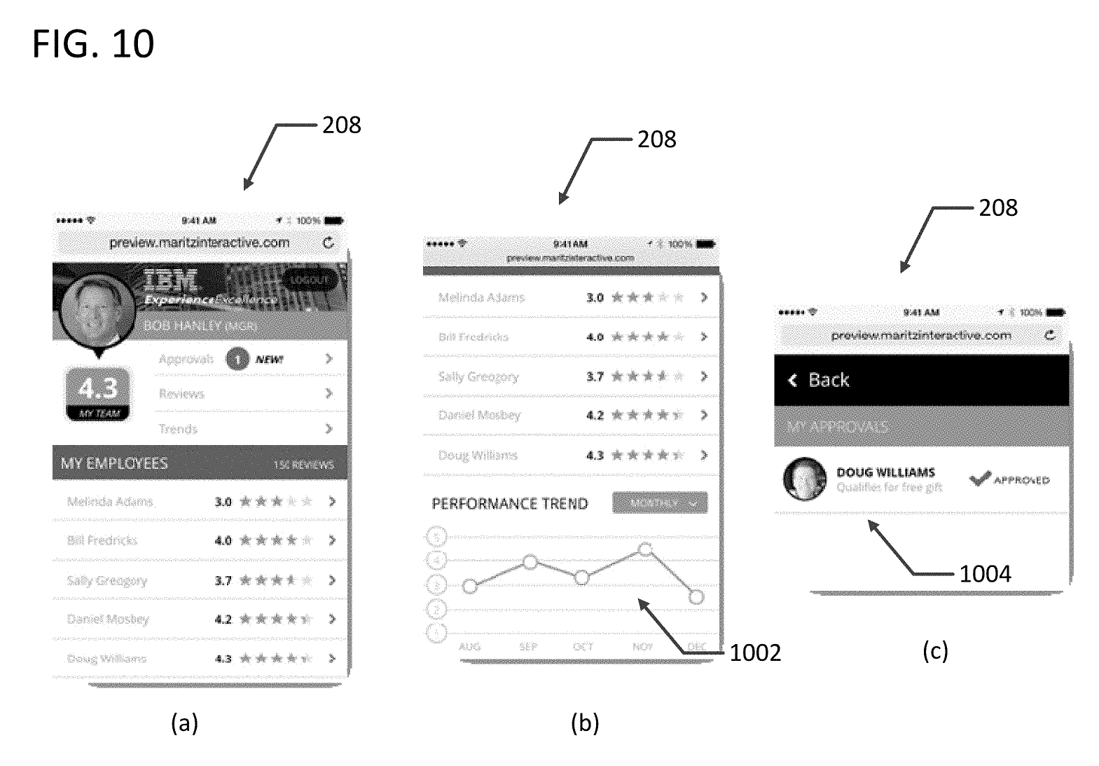

FIG. 10 illustrates aspects of an exemplary manager feedback event in accordance with an aspect of the invention. As illustrated in frame (a), manager computing device 108 displays response insights display 208. In this embodiment, response insights display 208 includes an aggregate score of participants managed by the manager, a notification of new rewards awaiting approval and a link therefor, a link for reviews, and a link for trends. In an embodiment, real-time engagement application 206 transmits an alert (e.g., a text message, email, etc.) to manager computing device 108 when a new reward is awaiting approval. In addition to the aggregate score of participants managed by the manager, the exemplary embodiment of response insights display 208 includes scores for individual participants managed by the manager. The exemplary embodiment of response insights display 208 also includes a monthly performance trend 1002 of the aggregate score of participants as illustrated in frame (b). The performance trend 1002 may also be displayed as weekly, quarterly, and the like. In response to selection of the notification of new rewards awaiting approval in frame (a), response insights display 208 on manager computing device 108 displays the participant reward 1004 awaiting approval, as illustrated in frame (c).

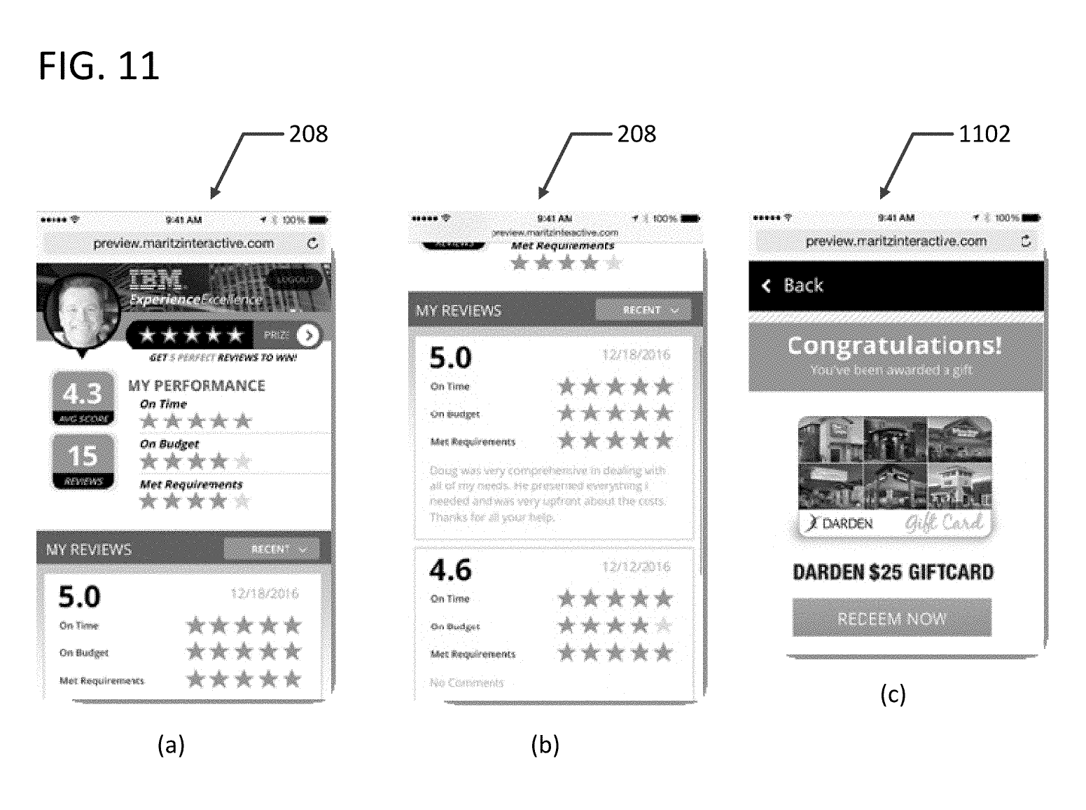

FIG. 11 illustrates aspects of an exemplary participant feedback event in accordance with an aspect of the invention. In an embodiment, a communication is transmitted to participant computing device 110, which displays the communication with a link to response insights display 208 in response to receiving it. Although illustrated in FIG. 11 as being displayed in the form of a text message, one of ordinary skill in the art will understand that the communication being displayed in other manners (e.g., email, pop-up notification, etc.) is within the scope of the present disclosure. Selection of the link causes participant computing device 110 to load and display response insights display 208, as shown in frame (a). In the embodiment illustrated in frame (b), response insights display 208 includes an average score for the participant, a total number of reviews for the participant, scores for participant timelines, budget concerns, and requirements concerns (e.g., a ranking from zero to five stars). Moreover, response insights display 208 includes individual reviews, with a review score, scores for the categories, and textual comments. The response insights display 208 also includes a prize notification 1102 in an embodiment. Selection of the prize notification notifies the participant of earned rewards and the ability to redeem the earned rewards (e.g., including all combined program earnings), as illustrated in frame (c).

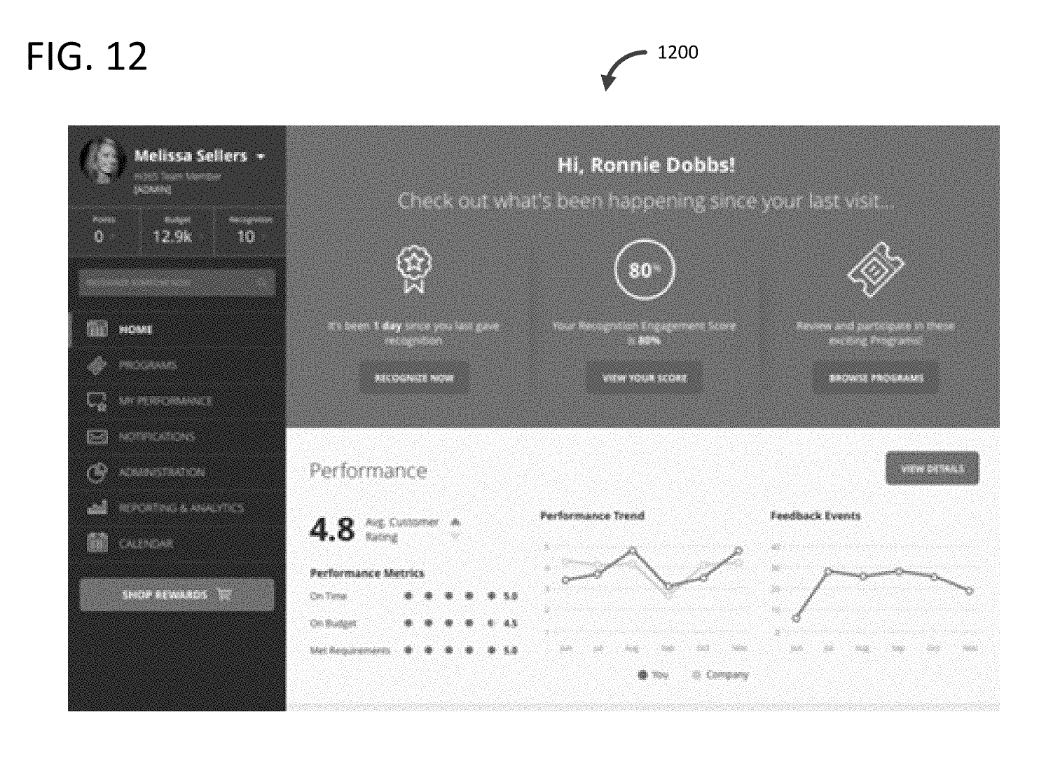

FIG. 12 illustrates an exemplary screenshot 1200 displayed by participant computing device 110 in accordance with an aspect of the invention. The screenshot 1200 displays a home page including aggregate customer-to-participant feedback metrics.

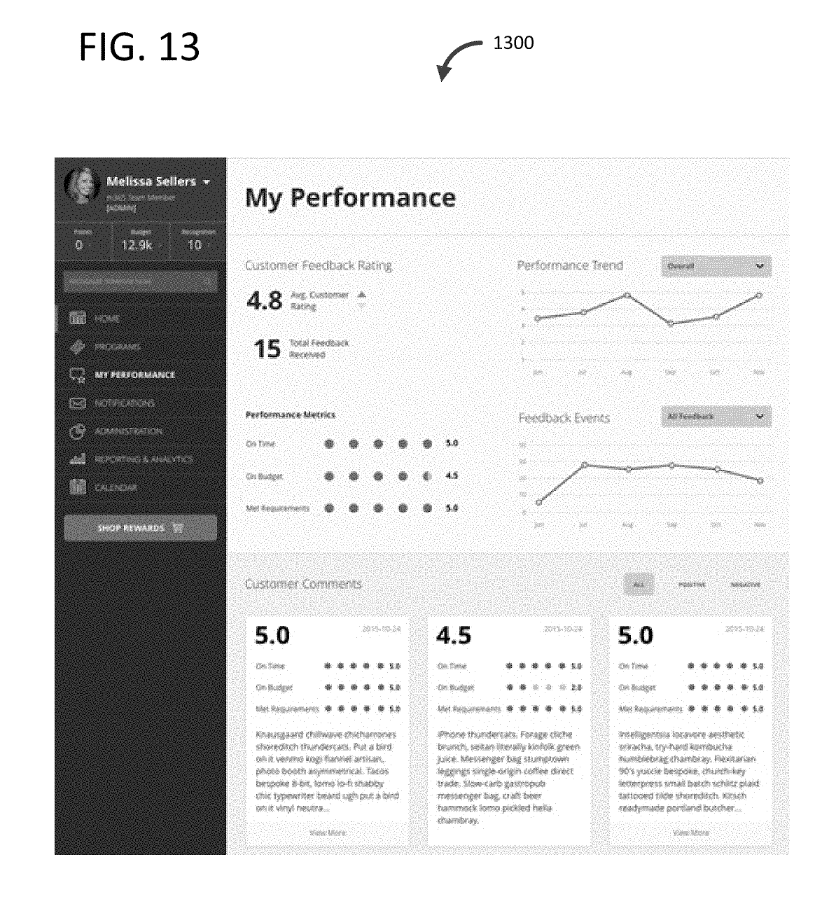

FIG. 13 illustrates an exemplary screenshot 1300 displayed by participant computing device 110 in accordance with an aspect of the invention. The screenshot 1300 displays a dedicated page including customer-to-participant feedback details (e.g., verbatim customer feedback).

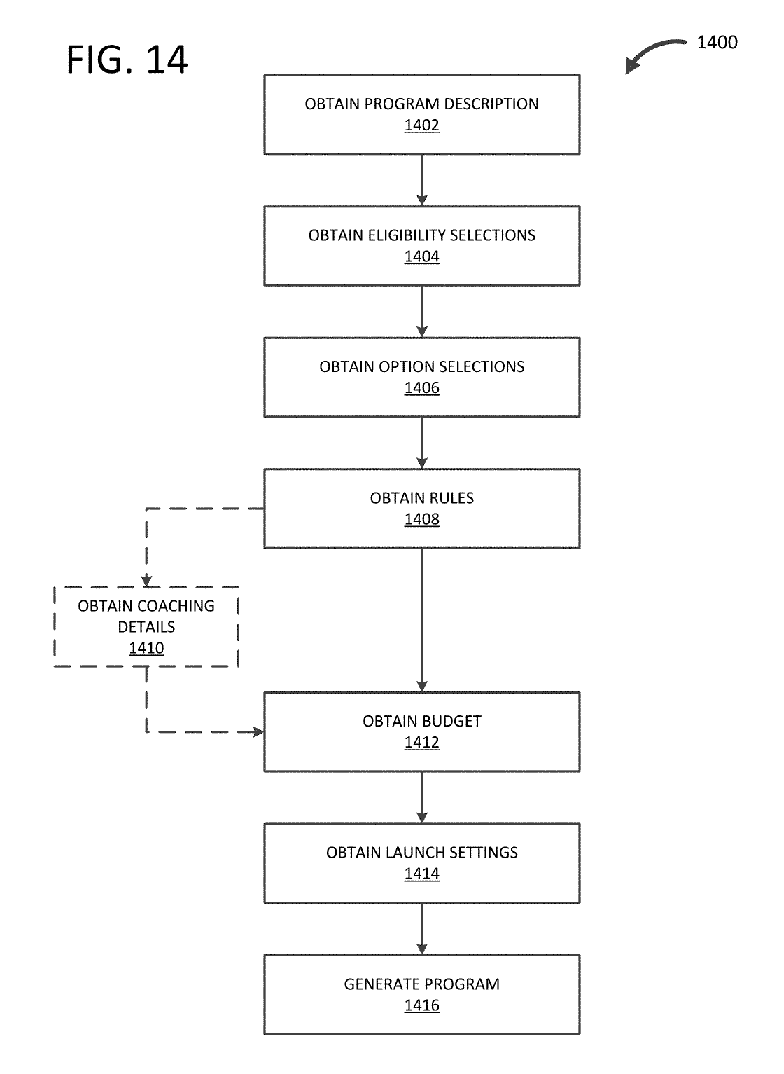

FIG. 14 illustrates an exemplary rule building process, generally indicated at 1400, for building CSAT program rules 210. In an embodiment, engagement computing device provides rules display 212 to manager computing device 108, which displays the rules display 212 (e.g., to an administrator that determines each aspect, etc.) to perform rule building process 1400. At 1402, engagement computing device 106 obtains, via rules display 212, a description for the customer to employee reward program. For example, the description may include a program name, a short textual description (e.g., 2000 characters or less), a long textual description (e.g., more than 2000 characters), a program image, or the like. At 1404, engagement computing device 106 obtains, via rules display 212, eligibility selections for the reward program. For example, the eligibility selections may include one or more individual users (e.g., employees, participants, etc.) and/or groups of users (e.g., all employees, participants, or the like at a common location, etc.). At 1406, engagement computing device 106 obtains program options via rules display 212. Exemplary program options include, but are not limited to, indicating survey response data inputs (e.g., file, pre-built integration), mapping response data to participant data, and label/display configurations that tailor response insights display 208, rules display 212, and earnings/leaderboard display 214. At 1408, engagement computing device 106 obtains rules. Exemplary rules include, but are not limited to, award issuance amounts and criteria/thresholds for determining award recipients. Specifically, a program may combine rules that determine an award amount, distribution method (e.g., “all participants at a winning location”, etc.), scoring options (e.g., rank and/or threshold at a fixed point in time or based upon a change over time, etc.), frequency of rule calculation (e.g., once, daily, weekly, etc.), rule-specific budget, and the like. Optionally, engagement computing device 106 obtains, via rules display 212, coaching details at 1410. For example, coaching details include configuration of content associated with specific questions that detail various aspects of the overall feedback event. For example, each feedback event may include specific questions about cleanliness, friendliness, and the like. Coaching details allow an administrator (e.g., via manager computing device 108) to add content that supports the display of specific messages when a goal has been achieved and/or when the goal has not been achieved. At 1412, engagement computing device 106 obtains, via rules display 212, one or more budgets. For example, the budget(s) may specify restrict the amount of rewards (e.g., gift cards, etc.) available for issuance by a rule or program. At 1414, engagement computing device 106 obtains, via rules display 212, launch settings for the rewards program. In an embodiment, launch settings include a starting (e.g., launch) date and an end date for the program. At 1416, engagement computing device 106 generates and implements the rewards program.

In an embodiment, a system (e.g., real-time engagement system) includes an engagement computing device (e.g., engagement computing device 106) and a participant computing device (e.g., participant computing device 110) communicatively coupled via a communications network. The engagement computing device includes an engagement processor (e.g., processor 302) and a memory device (e.g., memory 304) communicatively coupled to the engagement processor. The memory device stores processor readable instructions that, when executed by the processor, provide a real-time engagement application (e.g., real-time engagement application 206). The real-time engagement application is configured to receive survey data from a survey computing device (e.g., survey computing device 104) communicatively coupled to the engagement computing device via the communications network. The executing application is further configured to aggregate the received survey data and analyze the aggregated survey data against one or more rules (e.g., program rules 210 stored in rules database 216, etc.) in real-time to generate a score (e.g., aggregate score 502, recognition engagement score 504, rank indicia 606, overall score indicia 608, score sub-dimension indicia 610, etc.) indicative of a quality of service rendered by a current participant to a current customer who entered the survey data on the survey computing device. For example, engagement computing device, via the executing application, is configured to aggregate and analyze the survey data within a short temporal period (e.g., within milliseconds) of receiving it so that the analysis results are available substantially immediately. The executing application is configured to generate a response insights display (e.g., response insights display 208) in real-time (e.g., within a short temporal period of the analysis) that includes the score. And the executing application is configured to transmit a communication (e.g., text message, etc.) including a uniform resource locator (URL) to the participant computing device in real-time (e.g., within a short temporal period of the generation) via the communications network. The URL specifies the location of the response insights display in the memory device of the engagement computing device. The participant computing device includes a participant processor and a memory device communicatively coupled to the participant processor. The memory device stores processor readable instructions that, when executed by the participant processor, configure the participant computing device to receive the communication from the engagement computing device via the communications network and enable connection of the participant computing device to the location of the response insights display in the memory device of the engagement computing device. The connection is enabled via the URL and is for rendering a display of the score in the response insights display on the participant computing device (e.g., via a display device thereof). In an aspect the receiving and enabling are performed by the participant computing device in real-time such that the response insights display including the score is available for display on the participant computing device relatively quickly (e.g., within a short temporal period, such as within milliseconds, etc.) after the engagement computing device receiving the survey data so that it is available substantially immediately as feedback to the participant.

In an aspect, the real-time engagement application executed by the engagement processor is further configured to transmit the communication including the URL to a manager computing device (e.g., manager computing device 108) in real-time (e.g., within a short temporal period of generating the response insights display) via the communications network. In another aspect, the system further comprises the manager computing device communicatively coupled to the engagement computing device via the communications network. The manager computing device includes a manager processor and a memory device communicatively coupled to the manager processor. The memory device stores processor readable instructions that, when executed by the manager processor, configure the manager computing device to receive the communication from the engagement computing device via the communications network and enable connection of the manager computing device to the location of the response insights display in the memory device of the engagement computing device. The connection is enabled via the URL and is for rendering a display of the response insights display on the manager computing device (e.g., via a display device thereof) to generate a rewards program for one or more participants. In an embodiment, the receiving and enabling are performed by the manager computing device in real-time such that the response insights display is available for display on the manager computing device relatively quickly (e.g., within a short temporal period, such as within milliseconds, etc.) after the engagement computing device receiving the survey data so that it is available substantially immediately as feedback to the manager.

In yet another aspect, the processor readable instructions stored on the memory device of the manager computing device, when executed by the manager processor, configure the manger computing device to access a rules display (e.g., rules display 212) via the real-time engagement application executing on the engagement computing device. The real-time engagement application executing on the engagement computing device is further configured to obtain (1402) a program description for the rewards program from the manager computing device via the rules display. The real-time engagement application executing on the engagement computing device is also configured to obtain (1404) eligibility selections defining participants eligible for the rewards program from the manager computing device via the rules display. The real-time engagement application executing on the engagement computing device is further configured to obtain option selections (1406), rules (1408), a budget (1412), and launch settings (1414) for the rewards program from the manager computing device via the rules display. Optionally, the real-time engagement application executing on the engagement computing device is further configured to obtain (1410) coaching details for the rewards program from the manager computing device via the rules display. And the real-time engagement application executing on the engagement computing device is configured to generate the rewards program as a function of the obtained parameters.

In another aspect, the real-time engagement application executed by the engagement processor is further configured to generate a reward for the current participant when the score exceeds a predetermined threshold (e.g., a goal, etc.).

In yet another aspect, receiving the survey data from the survey computing device includes receiving (402) the survey data indicative of the quality of service rendered by the current participant and one or more other participants to the current customer, the current participant and the other participants comprising a group having a common identifying property (e.g., geographic location, branch, store, etc.). Aggregating the received survey data includes aggregating (404) the received survey data for the group and analyzing the aggregated survey data includes analyzing (404) the aggregated survey data against the rules to generate an aggregate group score indicative of the quality of service rendered by the group to the current customer and other customers over time. In an aspect, the real-time engagement application executed by the engagement processor is configured to generate (406) a reward for the group when the aggregate group score exceeds a predetermined threshold. In another aspect, the real-time engagement application executed by the engagement processor is configured to generate (408) a reward for the group when the particular group score exceeds a predetermined threshold.

In another aspect, the score is comprised of sub-dimensions (e.g., score sub-dimension indicia 610) each indicative of a property of the service rendered to enable the current participant to focus attention on one or more of the service properties.

In one form, aspects of the invention enable participants to feel more connected to the result of their service performance. In another form, real-time feedback aspects of the invention enable participants to correct errors and improve service performance. In yet another form, aspects of the invention increase customer satisfaction. Aspects of the invention enable greater participant service productivity and increased revenue from increased customers served and increased business derived from customer satisfaction.

In one aspect, the systems and methods described herein are configured as “closed,” meaning the systems and methods provide real-time feedback to participant computing devices automatically without any intermediate review or intervention by an individual. In this aspect, there is no human filtering of the feedback that is processed and provided. The response insights display to the participant computing device is provided in real-time without filtering in order to maximize the impact and establish a direct correlation in timeliness between the survey data and the response insights display provided. For example, a participant can associate feedback with a particular event or transaction because of the real-time connection between the event/transaction, the feedback, and the response insights display provided to the participant.

Embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, solid state drives (SSDs), and the like.

The computer typically includes a variety of computer readable media. Computer readable media can be any available media that can be accessed by the computer and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media are non-transitory and include, but are not limited to, RAM, ROM, EEPROM, flash memory or other memory technology, CD-ROM, digital versatile disks (DVD) or other optical disk storage, SSDs, magnetic cassettes, magnetic tape, magnetic disk storage or other magnetic storage devices, or any other medium which can be used to store the desired non-transitory information, which can accessed by the computer. Alternatively, communication media typically embody computer readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as video adapter 48. In addition to the monitor, personal computers typically include other peripheral output devices (not shown), such as speakers and printers.

One or more aspects of the disclosure may be embodied in computer-executable instructions (i.e., software), routines, or functions stored in system memory or non-volatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The embodiments illustrated and described herein may include additional or fewer operations than those disclosed herein. For example, it is contemplated that executing or performing a particular operation before, contemporaneously with, or after another operation is within the scope of aspects of the disclosure.

Embodiments may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system, comprising:
an engagement computing device, comprising:
an engagement processor, and
a memory device communicatively coupled to the engagement processor, the memory device storing processor readable instructions thereon that, when executed by the engagement processor, provide a real-time engagement application configured to:
receive survey data from a survey computing device communicatively coupled to the engagement computing device via a communications network,
aggregate the received survey data in real-time,
analyze the aggregated survey data against one or more rules in real-time to generate a score indicative of a quality of service rendered by a current participant to a current customer who entered the survey data on the survey computing device,
generate a response insights display in real-time, the response insights display including the score, and
transmit a communication including a uniform resource locator (URL) to a participant computing device in real-time via the communications network, the URL specifying the location of the response insights display in the memory device; and
the participant computing device communicatively coupled to the engagement computing device via the communications network, the participant computing device comprising:
a participant processor, and
a memory device communicatively coupled to the participant processor, the memory device storing processor readable instructions thereon that, when executed by the participant processor, configure the participant computing device to:
receive the communication from the engagement computing device via the communications network, and
enable connection, via the URL, of the participant computing device to the location of the response insights display in the memory device of the engagement computing device for rendering a display of the score in the response insights display.

2. The system of claim 1, wherein the real-time engagement application executed by the engagement processor is further configured to transmit the communication including the URL to a manager computing device in real-time via the communications network.

3. The system of claim 2, further comprising the manager computing device communicatively coupled to the engagement computing device via the communications network, the manager computing device comprising:
a manager processor, and
a memory device communicatively coupled to the manager processor, the memory device storing processor readable instructions thereon that, when executed by the manager processor, configure the manager computing device to:
receive the communication from the engagement computing device via the communications network, and
enable connection, via the URL, of the manager computing device to the location of the response insights display in the memory device of the engagement computing device for rendering the response insights display to generate a rewards program.

4. The system of claim 3,
wherein the processor readable instructions stored on the memory device of the manager computing device, when executed by the manager processor, configure the manager computing device to access a rules display via the real-time engagement application executing on the engagement computing device, and
wherein the real-time engagement application executed by the engagement processor is further configured to:
obtain, from the manager computing device via the rules display, a program description for the rewards program,
obtain, from the manager computing device via the rules display, one or more eligibility selections defining participants eligible for the rewards program,
obtain, from the manager computing device via the rules display, one or more option selections for the rewards program,
obtain, from the manager computing device via the rules display, one or more rules for the rewards program,
obtain, from the manager computing device via the rules display, a budget for the rewards program,
obtain, from the manager computing device via the rules display, launch settings for the rewards program, and
generate the rewards program as a function of the obtained program description, eligibility selections, option selections, rules, budget, and launch settings.

5. The system of claim 1, wherein the real-time engagement application executed by the engagement processor is further configured to:
generate a reward for the current participant when the score exceeds a predetermined threshold, and
combine the generated reward with other program earnings.

6. The system of claim 1,
wherein said receiving the survey data from the survey computing device comprises receiving the survey data indicative of the quality of service rendered by the current participant and one or more other participants to the current customer, and
wherein the current participant and the other participants comprise a group having a common identifying property.

7. The system of claim 6,
wherein said aggregating the received survey data comprises aggregating the received survey data for the group,
wherein said analyzing the aggregated survey data comprises analyzing the aggregated survey data against the one or more rules to generate an aggregate group score indicative of the quality of service rendered by the group to the current customer and other customers over time, and
wherein the real-time engagement application executed by the engagement processor is further configured to generate a reward for the group when the aggregate group score exceeds a predetermined threshold.

8. The system of claim 6,
wherein said aggregating the received survey data comprises aggregating the received survey data for the group,
wherein said analyzing the aggregated survey data comprises analyzing the aggregated survey data against the one or more rules to generate a particular group score indicative of the quality of service rendered by the group to the current customer at a particular time, and
wherein the real-time engagement application executed by the engagement processor is further configured to generate a reward for the group when the particular group score exceeds a predetermined threshold.

9. The system of claim 1, wherein the score comprises one or more sub-dimensions each indicative of a property of the service rendered to enable the current participant to focus attention on one or more of the service properties.

10. A computer-implemented method of providing dynamic, real-time service feedback over a communications network to a participant computing device, comprising:
receiving, by a real-time engagement application executing on an engagement computing device, survey data from a survey computing device communicatively coupled to the engagement computing device via a communications network;
aggregating, by the real-time engagement application executing on the engagement computing device, the received survey data in real-time;
evaluating, by the real-time engagement application executing on the engagement computing device, the aggregated survey data against one or more rules in real-time to generate a score indicative of a quality of service rendered;
generating, by the real-time engagement application executing on the engagement computing device, a response insights display in real-time, wherein the response insights display includes the score;
storing the response insights display in a memory device of the engagement computing device; and
transmitting, by the real-time engagement application executing on the engagement computing device, a communication including a uniform resource locator (URL) to a participant computing device in real-time via the communications network, wherein the URL specifies the location of the response insights display in the memory device,
wherein the transmitted communication activates the participant computing device to cause the URL to display on the participant computing device and to enable connection of the participant computing device via the URL to the response insights display over the communications network when the URL is selected to render a display of the score on the participant computing device.

11. The method of claim 10,
wherein the survey data includes survey responses for a plurality of participants,
wherein said evaluating comprises, evaluating, by the real-time engagement application executing on the engagement computing device, the aggregated survey data against the one or more rules in real-time to generate the score, wherein the score comprises an aggregate feedback score indicative of the quality of service rendered by the plurality of participants to one or more customers who entered the survey data on the survey computing device, and
wherein said generating comprises generating, by the real-time engagement application executing on the engagement computing device, the response insights display in real-time to include a reward for each of the plurality of participants when the aggregate feedback score exceeds a predetermined threshold value.

12. The method of claim 10,
wherein the survey data includes survey responses for a plurality of participants,
wherein said evaluating comprises evaluating, by the real-time engagement application executing on the engagement computing device, the aggregated survey data against the one or more rules in real-time to generate the score, wherein the score is indicative of the quality of service rendered by the plurality of participants to a current customer who entered the survey data on the survey computing device, and
wherein said generating comprises generating, by the real-time engagement application executing on the engagement computing device, the response insights display in real-time to include a reward for each of the plurality of participants when at least one of the plurality of feedback scores exceeds a predetermined threshold value.

13. The method of claim 10,
wherein the survey data includes survey responses for a single participant,
wherein said evaluating comprises, evaluating, by the real-time engagement application executing on the engagement computing device, the aggregated survey data against the one or more rules in real-time to generate the score, wherein the score comprises an aggregate feedback score indicative of the quality of service rendered by the single participant to one or more customers who entered the survey data on the survey computing device, and
wherein said generating comprises generating, by the real-time engagement application executing on the engagement computing device, the response insights display in real-time to include a reward for the single participant when the aggregate feedback score exceeds a predetermined threshold value.

14. The method of claim 10,
wherein the survey data includes survey responses for a single participant,
wherein said evaluating comprises evaluating, by the real-time engagement application executing on the engagement computing device, the aggregated survey data against the one or more rules in real-time to generate the score, wherein the score is indicative of the quality of service rendered by the single participant to a current customer who entered the survey data on the survey computing device, and
wherein said generating comprises generating, by the real-time engagement application executing on the engagement computing device, the response insights display in real-time to include a reward for the single participant when the score exceeds a predetermined threshold value.

15. The method of claim 10, further comprising:
transmitting, by the real-time engagement application executing on the engagement computing device, the communication including the URL to a manager computing device in real-time via the communications network,
wherein the transmitted communication activates the manager computing device to cause the URL to display on the manager computing device and to enable connection of the manager computing device via the URL to the response insights display over the communications network when the URL is selected to render the response insights display on the manager computing device for generating a rewards program.

16. The method of claim 15, further comprising:
obtaining, by the real-time engagement application executing on the engagement computing device, a program description for the rewards program from the manager computing device;
obtaining, by the real-time engagement application executing on the engagement computing device, one or more eligibility selections from the manager computing device, wherein the eligibility selections define participants eligible for the rewards program;
obtaining, by the real-time engagement application executing on the engagement computing device, one or more option selections from the manager computing device;
obtaining, by the real-time engagement application executing on the engagement computing device, one or more rules for the rewards program from the manager computing device;
obtaining, by the real-time engagement application executing on the engagement computing device, a budget for the rewards program from the manager computing device;
obtaining, by the real-time engagement application executing on the engagement computing device, launch settings for the rewards program from the manager computing device; and
generating, by the real-time engagement application executing on the engagement computing device, the rewards program as a function of the obtained program description, eligibility selections, option selections, rules, budget, and launch settings.

17. A system, comprising:
a customer computer;
a survey computer;
an engagement computer;
a manager computer; and
a participant computer,
wherein the customer computer and the survey computer are communicatively coupled via a communications network,
wherein the survey computer and the engagement computer are communicatively coupled via the communications network,
wherein the manager computer and the engagement computer are communicatively coupled via the communications network,
wherein the participant computer and the engagement computer are communicatively coupled via the communications network,
wherein the manager computer is configured, by processor readable instructions executing thereon, to generate a rewards program for implementation by the engagement computer by providing one or more rules and a score goal to the engagement computer, said rewards program generated before a participant renders a service to a customer;
wherein the survey computer is configured, by processor readable instructions executing thereon, to transmit a survey to the survey computer via the communications network after the participant renders the service to the customer,
wherein the customer computer is configured, by processor readable instructions executing thereon, to receive the survey from the survey computer and display the survey in response to said receiving,
wherein the customer computer is configured, by processor readable instructions executing thereon, to receive survey selections from the customer and transmit survey data representative of the survey selections to the survey computer via the communications network in response to receiving the selections, the survey selections being objective indicia of the customer's subjective feedback regarding the participant's rendering of the service,
wherein the survey computer is configured, by processor readable instructions executing thereon, to store the received survey data in a survey response database thereon in response to receiving the survey data,
wherein the survey computer is configured, by processor readable instructions executing thereon, to transmit the survey data from the survey response database to the engagement computer via the communications network,
wherein the engagement computer is configured, by processor readable instructions executing thereon, to evaluate the survey data against the one or more rules stored thereon to generate a score indicative of a quality of the rendered service in response to receiving the transmitted survey data,
wherein the engagement computer is configured, by processor readable instructions executing thereon, to generate a response insights display including the score;
wherein the engagement computer is configured, by processor readable instructions executing thereon, to transmit a communication including a uniform resource locator (URL) to the participant computer via the communications network in response to said generating, the URL specifying the location of the response insights display on the engagement computer, and
wherein the participant computer is configured, by processor readable instructions executing thereon, to enable connection, via the URL and in response to receiving the communication, of the participant computer to the location of the response insights display on the engagement computer for rendering a display of the score and the score goal on the participant computer to enable the participant to understand, in real-time relative to receiving the survey selections from the customer, whether the customer's subjective feedback regarding the participant's rendering of the service met the score goal.

18. The system of claim 17,
wherein the engagement computer is configured, by processor readable instructions executing thereon, to transmit the communication including the URL to the manager computer via the communications network in response to said generating the response insights display, and
wherein the manager computer is configured, by processor readable instructions executing thereon, to enable connection, via the URL and in response to receiving the communication, of the manager computer to the location of the response insights display on the engagement computer for rendering a display of the score and the score goal on the manager computer to enable a manager of the participant to understand, in real-time relative to receiving the survey selections from the customer, whether the customer's subjective feedback regarding the participant's rendering of the service met the score goal.

19. The system of claim 17,
wherein the engagement computer is configured, by processor readable instructions executing thereon, to generate a reward for the participant when the score meets or exceeds the score goal,
wherein the engagement computer is configured, by processor readable instructions executing thereon, to transmit a communication including the reward in response to said generating the reward, and
wherein the participant computer is configured, by processor readable instructions executing thereon, to render a display of the reward on the participant computer.

20. The system of claim 17, wherein the score comprises one or more sub-dimensions each indicative of a property of the service rendered to enable the current participant to focus attention on one or more of the service properties.
